(19) United States
(12) Patent Application Publication
(10) Pub. No.: US 2013/0297518 A1
(43) Pub. Date: Nov. 7, 2013

(54) Recycling System

(71) Applicant: WMS METAL INDUSTRIES LLC, Dubai (AE)

(72) Inventors: Mohamed Nassar, Dubai (AE); Mostafa Nassar, Dubai (AE)

(73) Assignee: WMS METAL INDUSTRIES LLC, Dubai (AE)

(21) Appl. No.: 13/628,165

(22) Filed: Sep. 27, 2012

Related U.S. Application Data
(60) Provisional application No. 61/643,567, filed on May 7, 2012.

(51) Int. Cl. G06Q 10/00

(52) U.S. Cl. 705/308

(57) ABSTRACT

A recycling system includes a plurality of tracking devices, a conveying system, a scanning system and a monitoring system. Each of the tracking devices may be associated with at least one of a plurality of tracking codes. Each of the tracking codes is associated with at least one of a plurality of waste generating entities. The recycling system can scan the tracking devices of the waste portions as they are directed by and through the conveying system. The monitoring system receives information about the content of each of the waste portions and associates the content information with the tracking codes. Advantageously, the recycling system can then track compliance of the waste generating entities in a recycling disposal program.

### CROSS-REFERENCE TO RELATED APPLICATIONS

This application claims the benefit of U.S. Provisional Application No. 61/643,567, filed May 7, 2012, which is hereby incorporated by reference in its entirety.

### BACKGROUND

Conventional recycling systems consist of toggling sorters that allocate different types of waste to different bins. They suffer from theft and reliability problems.

It would be advantageous to have an improved recycling system that addresses such problems while encouraging compliance with recycling programs.

### SUMMARY

A recycling system for tracking recyclable waste portions submitted by waste generating entities to a recycling entity is provided. The system includes tracking codes, tracking devices, a conveying system, a scanning system and a waste portion content monitoring system. The tracking codes are associated with the waste generating entities. The tracking devices are associated with a waste portion and one of the tracking codes. The conveying system is configured to receive the waste portions from the waste generating entities. Also, the conveying system has a continuously secure pathway for conducting the waste portions to the at least one recycling entity. The scanning system is configured to scan the tracking devices of the waste portions and communicate the tracking codes associated therewith to a database. The waste portion content monitoring system is configured to receive information about the content of each of the waste portions and to associate the content information with the tracking codes.

A compliance evaluation system may be configured to determine the content information for a plurality of waste portions. Each of the waste portions is associated with at least one of the generating entities. A compliance report may be generated by the evaluation system for a waste generating entity. Also, an incentive system may be configured to distribute awards to the waste generating entity based on the compliance report.

The recycling system may also include a registration system configured to record identification information about the waste generating entities and to generate and associate the tracking codes with the waste generating entities.

The tracking devices may include a plurality of barcode stickers for placement on the containers.

The continuously secure pathway of the conveying system may include at least one exchange area between separable conveying portions. For example, the exchange area may be secured against manual access or tampering. An exchange area may be between a sorter and a trolley of the continuously secure pathway. The continuously secure pathway may also include a hood to bridge the exchange area between the sorter and the trolley. Further, the continuously secure pathway may include a trolley lock configured to immobilize the trolley with respect to the hood.

A chute may be included in the continuously secure pathway. The chute may have a closed periphery.

The sorter may include a rotating cylindrical sorter having an opening. The sorter may be configured to address at least two fixed trolleys by rotation of the opening. The exchange area may be a gap between the rotating cylindrical sorter and the hood. The rotating cylindrical sorter may include a fixed deflector configured to direct falling recyclable waste through the opening. A motor system may be included in the rotating cylindrical sorter, wherein the motor is configured to rotate the sorter. Also, the rotating cylindrical sorter may be detachable from the chute. Further, the continuously secure pathway may include a motor housing configured to shield the motor from environmental exposure.

The recycling system may also include a waste portion characterization system configured to determine a waste portion type. The waste portion characterization system may be configured to instruct the motor to rotate the rotating cylindrical chute based on the waste portion type. For example, the waste portion types may be paper, plastic, cans or non-recyclable waste.

A secure waste disposal system for disposal and sorting of waste portions may include a receptacle, a chute and a sorter. The receptacle is configured to receive the waste portions. The receptacle includes an input device configured to record a selected waste portion classification. The chute may be coupled to the receptacle and configured to guide the waste portions received from the receptacle. And, the sorter may be coupled to the chute and connected in communication with the input device. Fixed to a housing of the sorter may be a deflector. The housing and deflector are configured to rotate to one of a plurality of sort positions based on the selected waste portion classification.

The disposal system may include a motor configured to rotate the sorter about a vertical axis to the plurality of sort positions. For example, the motor may be mounted under the deflector and enclosed within a portion of the housing.

The receptacle, chute and sorter may define a continuously secure pathway including at least one exchange area between the sorter and a secondary transport mechanism. A hood may be configured to bridge the exchange area.

The secondary transport mechanism may be a trolley that is configured to lock with respect to the hood.

The housing may be a cylindrical housing and the cylindrical housing may be sufficiently close to the hood to block manual access.

The chute may have a closed periphery and the sorter may be detachable from the chute.

Advantageously, the recycling system can track compliance of the waste generating entities in a recycling disposal program. It can also improve security of conveyance of the waste portions.

### BRIEF DESCRIPTION OF THE SEVERAL VIEWS OF THE DRAWINGS

FIG. 1 is a schematic of a recycling or waste disposal system;

FIG. 2 is an elevation view of a conveying system;

FIG. 3 is a perspective view of the conveying system of FIG. 2;

FIG. 4 is a side elevation view of another conveying system;

FIG. 5 is a perspective view of a receptacle of the conveying system of FIG. 2;

FIG. 6 is a side elevation view of another conveying system;

FIG. 7 is a plan view of a foot print of the conveying system of FIG. 8;

FIG. 8 is a side elevation view of a another conveying system;

FIG. 9 is a flow diagram of a process for recycling; and

FIG. 10 is a schematic of a monitoring system for monitoring recycling.

### DETAILED DESCRIPTION

The terminology used herein is for the purpose of describing particular implementations only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

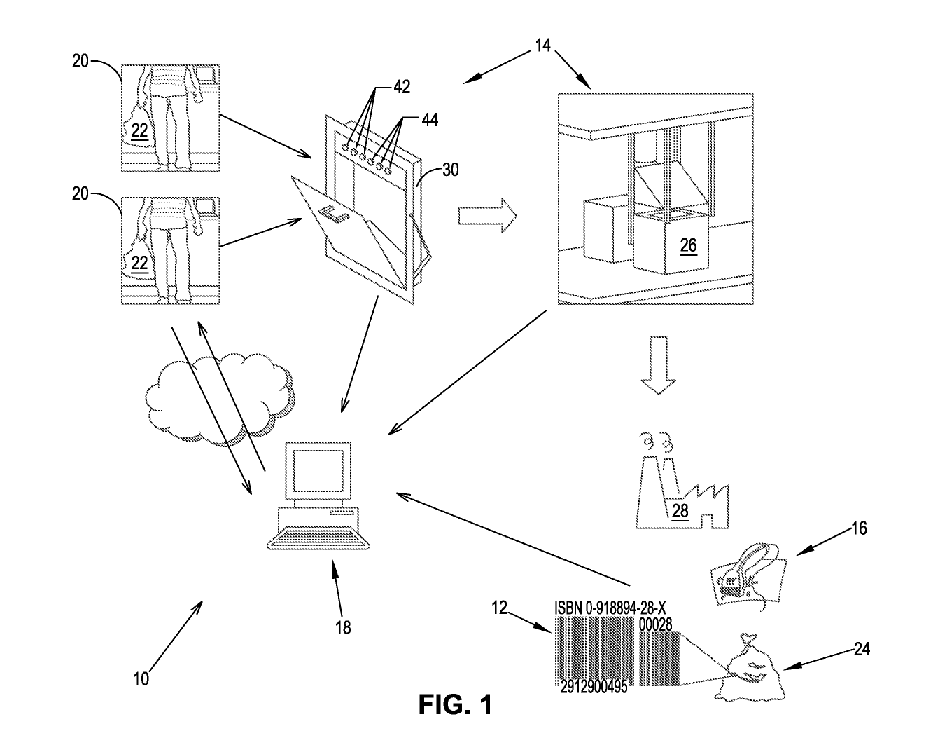

With reference now to FIG. 1, implementations of a recycling system 10 include a plurality of tracking devices 12, a conveying system 14, a scanning system 16, a monitoring system 18 and a processing center 28. Each of the tracking devices 12 may be associated with at least one of a plurality of tracking codes. Each of the tracking codes is associated with at least one of a plurality of waste generating entities 20. The recycling system 10 can scan the tracking devices 12 of the waste portions 22 as they are directed by and through the conveying system 14. The monitoring system 18 receives information about the content of each of the waste portions 22 and associates the content information with the tracking codes. Advantageously, the recycling system 10 can track compliance of the waste generating entities 20 in a recycling disposal program. It can also improve security of conveyance of the waste portions 22.

Any combination of one or more computer readable medium(s) may be used in implementations of the present invention, such as the monitoring system 18. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to implementations of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring again to FIG. 1, the waste generating entities 20 submits the waste portions 22 to the recycling system 10. The waste generating entities 20 may be individuals, such as apartment dwellers, or may be industrial or group customers with large or consolidated waste portions 22. Waste portions 22 may include, for example, recyclable and non-recyclable waste portions. Recyclable waste portions may be defined, for example, by applicable recycling technology (and expand with the improvement of such technology) or laws, rules or regulations, or a combination of both. Recyclable waste portions may be comprised of one or more of paper, plastic, metals, such as aluminum or steel cans. Non-recyclable waste may be comprised of those things that are incapable of or unsafe for recycling. Waste portions 22 may also include compostable waste that may be used as organic soil supplements or as fuel.

Each of the waste portions 22 may be in a container 14 or may be isolated, identifiable portions of a stream of waste portions. Containers may be bags, boxes, trays or string for bundles, for example, that consolidate waste into tidy portions for ease of handling.

Regardless of how the waste portions 22 are defined, the tracking devices 12 are associated with the waste portions 22 to facilitate their tracking. For example, the containers 24 may have affixed thereto a barcode, such as a label 27 bearing a barcode, an RFID tag, a maxi-code, an alphanumeric sequence, a color or pattern printed thereon or some other identifiable characteristic that can be associated with one of the waste generating entities 20. The tracking device may even a characteristic not purposefully placed but associated with the type or style of origination or processing of the waste generating entity. For example, one generating entity might use a square compactor that generates square waste portions that can be associated, by its square shape, with that generating entity.

As shown in FIG. 1, the conveying system 14 extends between the waste generating entities 20 and includes one or more secondary transport mechanisms, such as a trolley 26, trucks, carts, trains, etc., that can convey the waste portions 22 to the processing center 28. The conveying system 28 is configured to more securely convey the waste portions 22 between the waste generating entities 20 and the secondary transport mechanisms.

As shown in FIGS. 1-4, the conveying system 14 may include, for example, a hopper or receptacle 30, a chute 32, a sorter 34 and a hood 36. Although these particular components are shown as an example of one conveying system 14, multiple components could be arranged in varying combinations to convey the waste portions 22 along a route between the waste generating entities 20 and the processing center(s) 28 and/or secondary transport mechanisms. To this end, multiple, more or fewer, chutes 32, receptacles 30, hoods 36 or other components may be assembled to generate a relatively secure pathway.

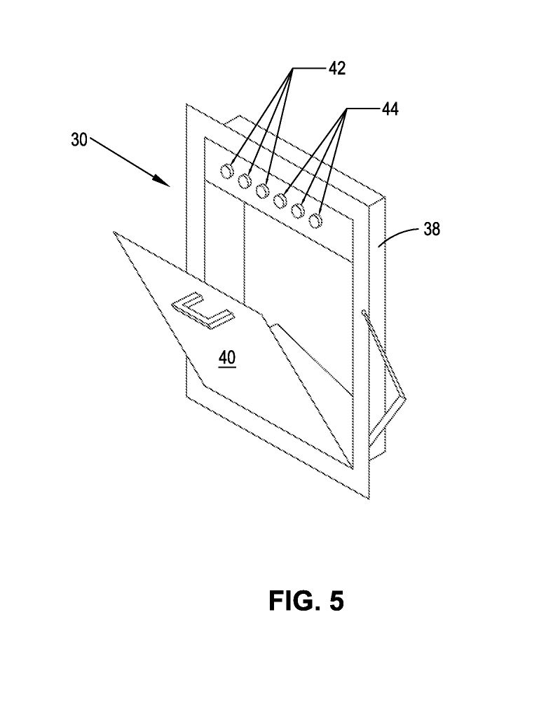

The receptacle 30, as shown in FIG. 5, includes an outer frame 38, a door 40, a plurality of pilot lamps 42 and a plurality of push buttons 44. The frame 38 is mounted in a building wall or other facility above the chute 32. The door 40 is hinged to swing open and reveal an inner passageway defined by the chute. The pilot lamps include a first color (on the far left) that indicates that the chute 32 is available for use. A second color (second from the left) pilot lamp 42 indicates that the sorter 34 is currently in operation. This light might also indicate a countdown from last use of the chute or the sorter 34. The pilot lamp 42 third from the left is configured to indicate that the chute is not available for use, such as due to cleaning or use by other entities.

The push buttons 44 are configured for the various recycling options. For example, a yellow button may be for glass. A black button may be for waste and a green button may be for paper. Other additional buttons may be employed for additional recyclable classifications.

During use, the entities (such as tenants in a building) 20 sort the type of refuse in as many fractions or waste portions 22 as required and dispose of the refuse bags (containers 24) in a garbage room of the building. One of the push buttons 44 is selected denoting the type of garbage. Once the button is selected, a control signal is sent to the sorter 34 (which responds in a manner as described below) and an unlocking mechanism may allow the door 40 to be opened.

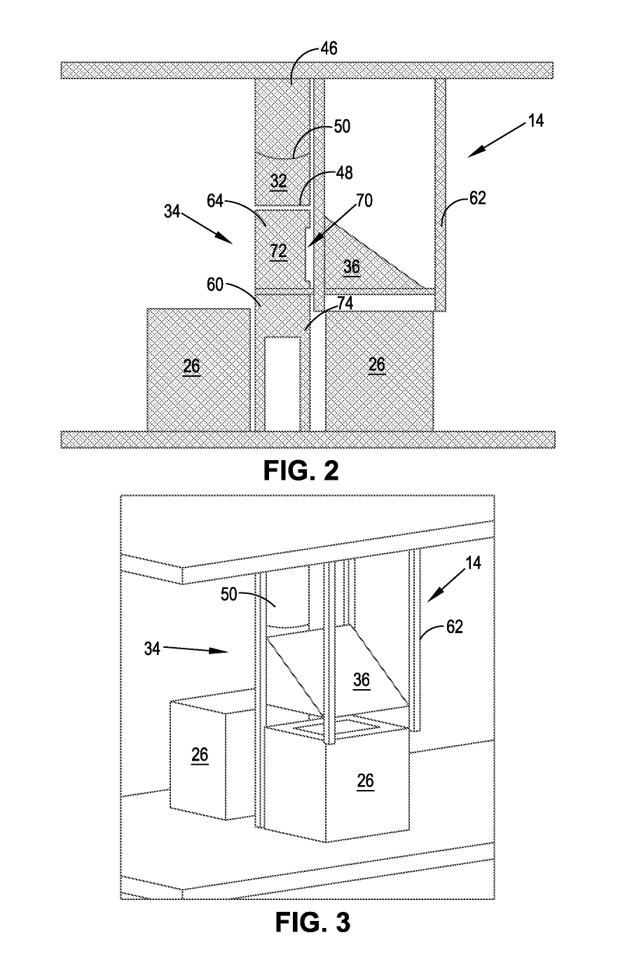

As shown in FIGS. 2-4 the chute 32 may have a head end 46, a bottom end 48 and a wall structure 50. The head end 46 is positioned adjacent to the receptacle 38 so as to receive any waste portions 22 submitted through the receptacle. The bottom end 48 is positioned above and adjacent to the sorter 34. Between the ends 46 and 48 the wall structure 50 encloses a passageway and directs the waste portions 22 to the sorter 34. The enclosed wall structure 50 advantageously protects the waste portions 22 from being displaced or stolen.

The chute 32 may be long or short. It may pass through many floors in a building or merely be a short length defining a short passage between the receptacle 30 and the sorter 34.

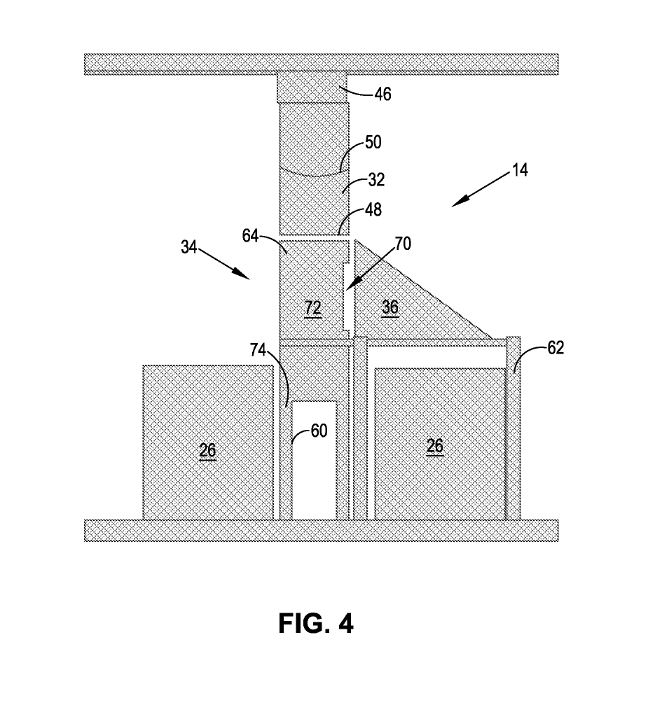

As shown in FIGS. 2-4, the sorter 34 may be supported from below by a pedestal 60 including a collection of struts extending from the ground. The pedestal 60 may be positioned adjacent the hood 36 which itself is supported by a hood frame 62. The hood frame 62, for example, may be a plurality of struts suspended from the ceiling or overhead structure, as shown in FIGS. 2 and 3. In FIG. 4, the hood frame 62 includes struts extending from the ground like the pedestal 60 of the sorter 34. It should be noted that either frame, however, could include varying parts and be affixed to different other structures. However, the pedestal 60 and hood frame 62 have the advantage of security if permanently fixed so as to be immovable by most manual means.

The hood 36 may be a structure that is configured to block any intervening spaces between portions of the conveying system 14 or the conveying system and additional transport mechanisms. For example, as shown in FIGS. 2-4, the hood 36 includes an angled, rectangular sheet metal portion extending down from the sorter 34 toward a trolley station. Sheet metal sides flank the angled portion and have a triangular shape to block the pathway under the angled portion.

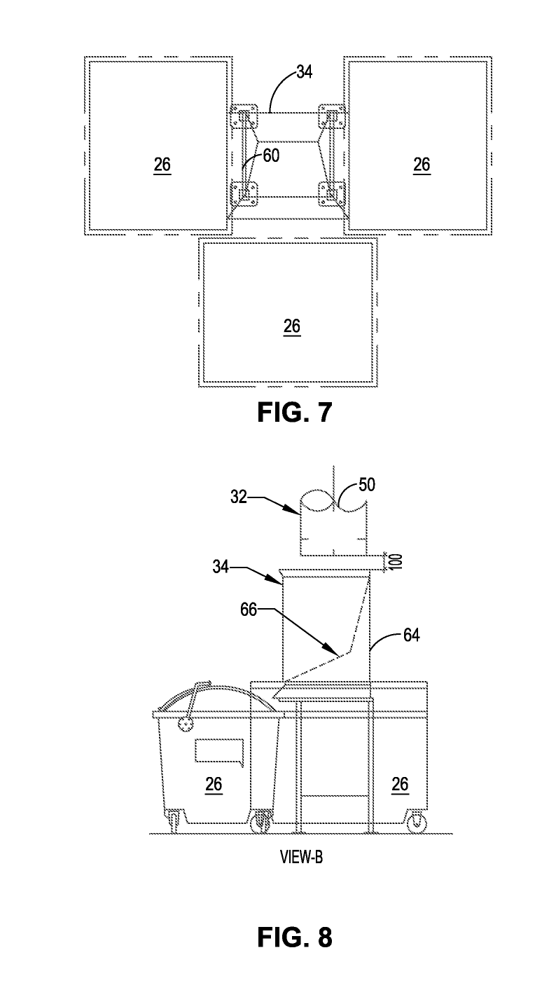

The trolley station includes one or more trolley locks configured to secure the trolley 26 or other secondary transport mechanism with respect to the hood 36. These locks are secured against release by all but authorized personnel. Two trolleys 36 are shown, but multiple trolleys may be used based on the number of types of recyclables being subdivided from the waste portions. For example, for refuse, paper, plastic and glass, there would be four trolleys or carts or other secondary transport mechanisms. As shown in FIG. 7, three trolleys 26 are used and surround the periphery of the sorter 34. Each of these may be bridged by a hood 36. Preferably, each of the trolleys (or other secondary transport systems) includes its own code or other indicia or tag (e.g., an RFID tag) that can be scanned and input into the monitoring system 18 to track its contents.

The secondary transport mechanisms may themselves be secure against tampering all the way to the processing center 28. For example, they may have locking lids and secure enclosures to guard against theft or loss. The trolleys may also be shorter or taller depending upon volumes and space constraints. The pathway from the end of the conveying system 14 may have several secondary transport mechanisms paired with one or more scanning systems 16 that communicate with the monitoring system 18 to track the progress of the waste portions 22 and containers 24. For example, the carts or trolleys may be dumped into trucks and the barcodes of the containers 24 scanned as each is placed in the trucks. The trucks can then transport the waste portions 22 to the processing center 28. Alternatively, the monitoring system 18 may correlate the tracking devices 12 detected at the receptacle 30 and the waste types entered via the push buttons 44 with the ID code of the trolley 26 so that the contents of the trolley are known and tracked. Similarly, the contents of the truck might be tracked based on the ID codes of the trolleys 26 loaded thereon and an ID code of the truck.

The processing center 28 may have its own scanning system(s) 16, as shown in FIG. 1, wherein each container 24 is scanned by a tracking device 12 as it comes off the truck or other secondary transport. This information is sent to the monitoring system 18. As will be discussed in more detail below, additional information on the contents of the containers 24 can be determined and sent to the monitoring system 18 for auditing and reporting compliance.

The processing center 28 is some type of processing or pre-processing facility (e.g., recycling center) that is capable of assessing the contents of the containers 24 or waste portions and then communicating those to the monitoring system 18. This information can be gathered and entered manually and by observation, or semi-automated or fully automated. For example, the scanning system 16 may be capable also of optical or sensor recognition and classification of the contents of the containers 24.

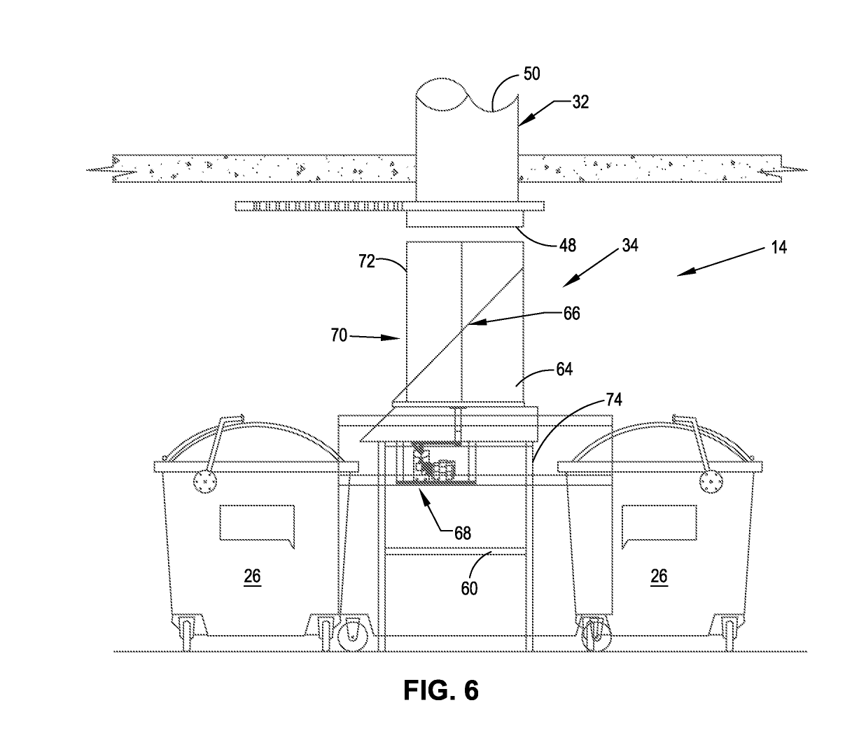

As shown in FIGS. 6 and 8, the sorter 34 includes a housing 64, a deflector 66 and a motor or drive 68. The housing 64 may be constructed of steel, stainless steel or other metal, or non-metals. The metals have the advantage of good durability and security. The housing 64 includes a top portion 72 and a bottom portion 74. The top portion 72 of the housing has a cylindrical shape and supports the deflector 66 therein. The deflector is an angled sheet of metal fixed to the top portion 72 and oriented in the direction of an opening 70 of the housing. The top portion 72 is also open at its top and is coupled to the bottom end of the chute 32. The deflector 66 may have a single angled surface, as shown in FIG. 6, or multiple angled surfaces, as shown in FIG. 8. The direction and number of the angled surfaces is configured to control the rate and path of travel of the containers 24 as they fall through from the chute. For example, more aggressive deflection occurs with higher angles while a more controlled ejection through the opening 70 into the selected trolley 26.

The bottom portion 74 of the sorter housing 64 has a rectangular metal structure that is enclosed about the motor and drive 68. The motor and drive 68 includes an electrical motor with a 190 watt output at 1.1 amps. It is configured to have an RPM of 1400 and acts through a speed reducer which has a vertically oriented, centrally located output shaft coupled to the upper portion 72 of the sorter housing 64. The weight of the top portion 72 is supported by a bearing that extends around the drive shaft and itself is supported by the bottom portion 74. The top portion 72 is thus configured to rotate around the axis passing through the output shaft as directed by the motor and drive 68. The bearing may be a thrust bearing to handle the weight of the top portion 72 and impact of containers 24 hitting the deflector 66.

It should be noted that other motors with higher and lower outputs, amperage or speed could be employed depending upon the expected size of the recycling fractions, frequency of use, etc. The motors may be DC, AC or use other power sources. Other styles and configurations of speed reducer could also be used or the motor-drive could be a direct drive system.

The motor drive 68 may be connected to a controller (IP 55 wall mounted controller with programmed PLC) that is in connected in communication with the receptacle 30. In particular, the push buttons 44 may communicate a type of recyclable fraction that's being deposited in the receptacle 30. The controller then directs the motor drive 68 to rotate the top portion 72 of the housing until its opening 70 is positioned under hood 36 that extends over the appropriate trolley 26 meant to capture that particular type of waste or recyclable. The top portion 72 may be rotated through a full 360 degrees and address multiple stations each with a trolley 26. Further, the motor and drive 68 are configured to rotate clockwise and counter clockwise through the shortest route to the desired station. Average delay time for switching stations is 7 seconds or less. Up to 5 conventional trolleys 26 may be addressed, more if the trolleys are smaller or modified for denser fit around the sorter 34.

Advantageously, fixing the deflector 66 relative to the top portion 72 of the sorter housing is an improvement over conventional sorters which have surfaces that toggle within the housing, rotating on a horizontal shaft, to change direction within the housing. Such conventional sorters have reliability issues because of the impact of falling waste. The fixed deflector 66 is much more robust because it is fixed to the top portion 72 which rotates as a whole unit.

In addition, the cylindrical or curved surfaces of the top portion 72 facilitate rotation of the top portion with minimal clearance provided between the hood frame 62 and the top portion. Thus, the exchange area between the outside of the top portion 72 of the housing and the adjacent surfaces of the hood 36 remain small and tight. This protects against hand or tool insertion, or other tampering, and removal of the containers 24 or waste portions.

Another advantage is provided by the bottom portion 74 which protects the motor and drive system 68 against tampering.

Another advantage is that the sorter 34 is detachable from the rest of the conveying system 14 for easy maintenance.

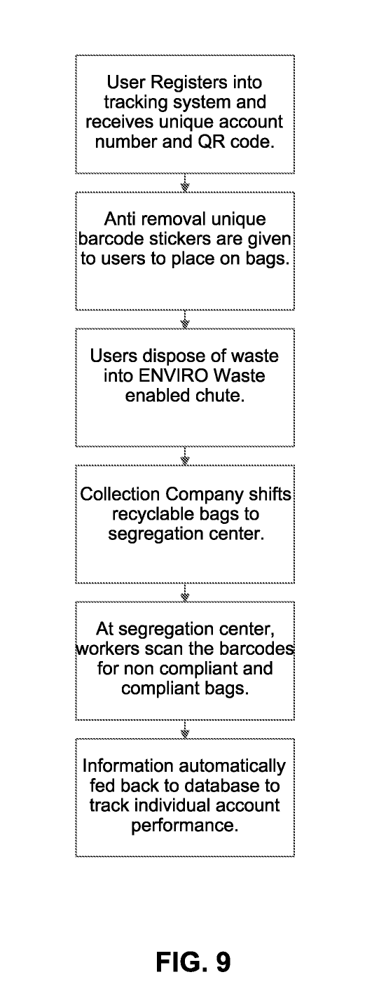

As shown in FIG. 9, a process may include registration by the waste generating entity with the monitoring system 18, such as through an internet web site. The monitoring system 18 then distributes a unique account number or QR code to the entity. The QR code is associated with the code on one of the tracking devices 12 which are distributed to the waste generating entity. The waste generating entity can then place the codes (such as by attaching labels) to the containers 24, which may be trash bags. The waste generating entity 20 then uses the conveying system 14 via the receptacle 30, as described above. The conveying system 14 and various secondary transport mechanisms then transport the containers 24 to the processing center 28. Optionally, the process may include intervening scanning of the tracking devices 12 using the scanning system 16 distributed along the route of travel.

At the processing center 28, the collection company shifts the containers 24 to its segregation facilities. The workers at the segregation facilities scan the barcodes using the scanning system 16 and record information regarding whether the contents of the containers 24 are compliant or non-compliant. For example, the scanned barcode is sent to the monitoring system 18 which relates to the worker that the waste portion 22 is supposed to contain only plastic. If not only or sufficiently composed of recyclable plastic, the worker records the occurrence as non-compliant along with the barcode associated with the tracking device 12. Segregation could also be more automated or fully automated. For example, robotic end effectors could grab and sort waste based on feedback from EM fields, optics and other sensors.

The monitoring system 18 associates this information using the barcode with the account in a database which can later be generated as a performance report. This performance report may be the basis for assessing penalties or incentives to the accountholder (waste generating entity). For example, monetary discounts or bonuses may be allocated to the account.

Thus, the system 10 may be configured to determine who is properly recycling and who is not. The system 10 is configured to create an online database. The entities 20 register with, and receive unique account numbers from the online database. The system 10 is particularly effective for enterprises administering recycling programs for large apartment buildings with large numbers of tenants. For example, each tenant household may have its own unique bar code associated with tracking devices 12 that are required (by property manager rule) to be placed on the container or bag 24. This bar code is then scanned at the collection or processing center 28. The bar code can be traced back to the residential unit. Once the container 24 is opened and it is confirmed that it includes recyclable materials it is then scanned and that particular tenant is identified as a “recycling tenant.” If the recyclable bag does not include recyclables the tenant is flagged as a “non-recycling tenant.” Thus, the system 10 can be a “closed loop” wherein the tenant originates the waste and then receives notice back of their compliance.

Advantageously, the system 10 facilitates household recycling without modifying current waste disposal behavior. The flexibility of the system 10 ensures easy adoption and minimal installation. Also, the system 10 can be retrofitted and implemented on existing buildings with pre installed garbage chutes or on new buildings that are under development.

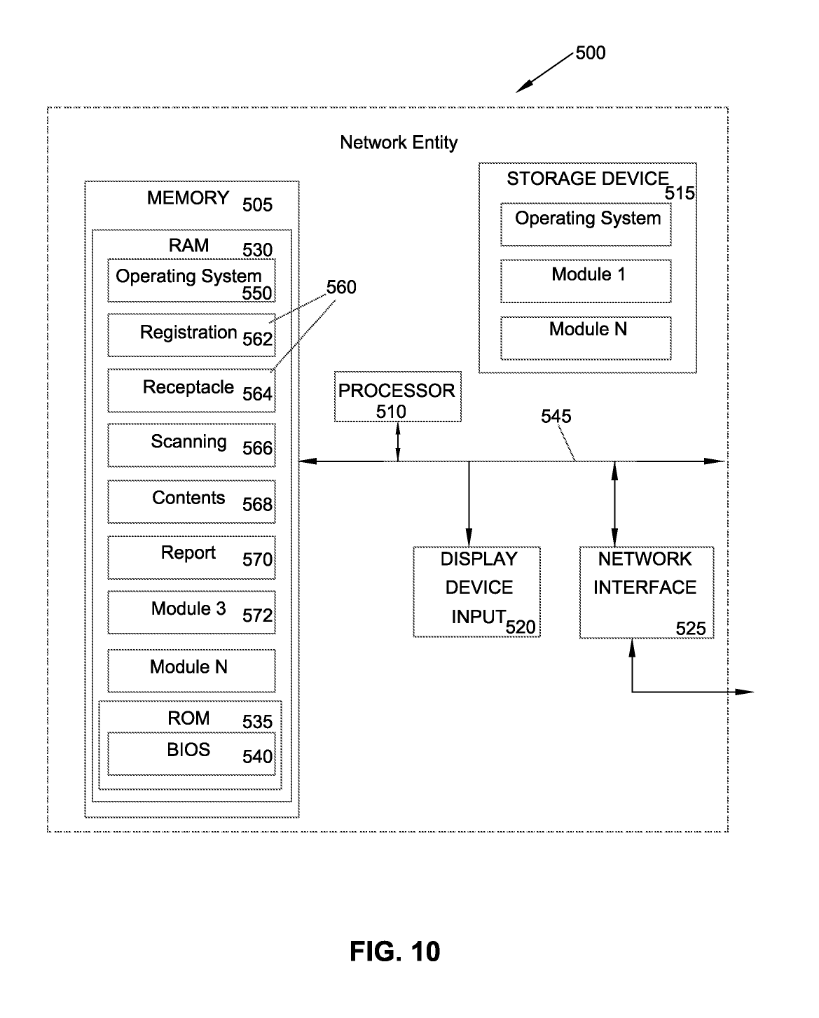

Referring now to FIG. 10, a schematic diagram of a central server 500, or similar network entity, configured to implement a recycling system 10, or monitoring system 18, is provided. As used herein, the designation “central” merely serves to describe the common functionality the server provides for multiple clients or other computing devices and does not require or infer any centralized positioning of the server relative to other computing devices.

As may be understood from FIG. 10, in this implementation, the central server 500 may include a processor 510 that communicates with other elements within the central server 500 via a system interface or bus 545. Also included in the central server 500 may be a display device/input device 520 (such as a scanner 16) for receiving and displaying data. This display device/input device 520 may be, for example, a keyboard or pointing device that is used in combination with a monitor.

The central server 500 may further include memory 505, which may include both read only memory (ROM) 535 and random access memory (RAM) 530. The server's ROM 535 may be used to store a basic input/output system 540 (BIOS), containing the basic routines that help to transfer information across the one or more networks.

In addition, the central server 500 may include at least one storage device 515, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 515 may be connected to the system bus 545 by an appropriate interface.

The storage devices 515 and their associated computer-readable media may provide nonvolatile storage for a central server. It is important to note that the computer-readable media described above could be replaced by any other type of computer-readable media known in the art. Such media include, for example, magnetic cassettes, flash memory cards and digital video disks.

A number of program modules may be stored by the various storage devices and within RAM 530. Such program modules may include an operating system 550 and a plurality of one or more (N) modules 560. The modules 560 may control certain aspects of the operation of the central server 500, with the assistance of the processor 510 and the operating system 550. For example, the modules may perform the functions described above and illustrated by the figures and other materials disclosed herein.

Modules 560, for example, may include a registration module 562 for registering waste generating entities, a receptacle module 564 for collecting information from the receptacle 30 of the conveying system 14, a scanning module 566 for tracking the movement of tracking devices 12 along the route, a contents module 568 for recording information on the contents of the containers 24 at the processing center 28 and a report module 570 for reporting compliance or non-compliance by a waste generating entity 20 and an incentive module 572 for providing the appropriate incentives.

The flowchart and block diagrams in the figures illustrate the architecture, functionality, and operation of possible implementations of systems, methods and computer program products according to various implementations of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The implementation was chosen and described in order to best explain the principles of the invention and the practical application, and to enable others of ordinary skill in the art to understand the invention for various implementations with various modifications as are suited to the particular use contemplated.

1. A recycling system for tracking recyclable waste portions submitted by waste generating entities to at least one recycling entity, the system comprising:
a plurality of tracking codes, each of the tracking codes associated with at least one of the waste generating entities;
a plurality of tracking devices, each of the tracking devices associated with at least one of the waste portions and one of the tracking codes;
a conveying system configured to receive the waste portions from the waste generating entities, the conveying system having a continuously secure pathway for conducting the waste portions to the at least one recycling entity;
a scanning system configured to scan the tracking devices of the waste portions and communicate the tracking codes associated with the waste portions to a database; and
a waste portion content monitoring system configured to receive information about content of each of the waste portions and to associate the content information with the tracking codes.

2. A system of claim 1, further comprising a compliance evaluation system configured to determine the content information for a plurality of the waste portions associated with at least one of the generating entities and to generate a compliance report for the generating entity.

3. A system of claim 2, further comprising an incentive system configured to distribute awards to the waste generating entity based on the compliance report.

4. A system of claim 1, further comprising a registration system configured to record identification information about the waste generating entities and to generate and associate the tracking codes with the waste generating entities.

5. A system of claim 1, wherein the tracking devices include a plurality of barcode stickers configured for placement on containers.

6. A system of claim 1, wherein the continuously secure pathway of the conveying system includes at least one exchange area between separable conveying portions and wherein the exchange area is secure against manual access.

7. A system of claim 6, wherein the at least one exchange area is between a sorter and a trolley of the continuously secure pathway.

8. A system of claim 7, wherein the continuously secure pathway includes a hood configured to bridge the exchange area between the sorter and the trolley.

9. A system of claim 8, wherein the continuously secure pathway includes a trolley lock configured to immobilize the trolley with respect to the hood.

10. A system of claim 9, wherein the continuously secure pathway of the conveying system includes a chute.

11. A system of claim 10, wherein the chute comprises a wall structure having a closed periphery.

12. A system of claim 11, wherein the sorter includes a rotating cylindrical sorter having an opening.

13. A system of claim 12, wherein the rotating cylindrical sorter is configured to address at least two fixed trolleys by rotation of the opening.

14. A system of claim 13, wherein the exchange area is a gap between the rotating cylindrical sorter and the hood.

15. A system of claim 14, wherein the rotating cylindrical sorter includes a fixed deflector configured to direct falling recyclable waste through the opening.

16. A system of claim 15, wherein the rotating cylindrical sorter includes a motor system configured to rotate the rotating cylindrical sorter.

17. A system of claim 16, wherein the rotating cylindrical sorter is detachable from the chute.

18. A system of claim 17, wherein the continuously secure pathway includes a motor housing configured to shield the motor from environmental exposure.

19. A system of claim 18, further comprising a waste portion characterization system configured to determine a waste portion type.

20. A system of claim 19, wherein the waste portion characterization system is configured to instruct the motor to rotate the rotating cylindrical chute based on the waste portion type.

21. A system of claim 20, wherein the waste portion type includes at least one of a paper, plastic, cans or non-recyclable waste.

22. A secure waste disposal system for disposal and sorting of waste portions, the disposal system comprising:
a receptacle configured to receive the waste portions, the receptacle including an input device configured to record a selected waste portion classification;
a chute having a first end and a second end, the first end being coupled to the receptacle and
a sorter coupled to the second end of the chute and in communication with the input device, the sorter having a deflector fixed to a housing, the housing and deflector configured to rotate to one of a plurality of sort positions based on the selected waste portion classification, wherein:
the chute is configured to guide the waste portions received from the receptacle to the sorter.

23. A disposal system of claim 22, further comprising a motor configured to rotate the sorter about a vertical axis to the plurality of sort positions.

24. A disposal system of claim 23, wherein the motor is mounted under the deflector.

25. A disposal system of claim 24, wherein the motor is enclosed within a portion of the housing.

26. A disposal system of claim 25, wherein the receptacle, chute and sorter define a continuously secure pathway including at least one exchange area between the sorter and a secondary transport mechanism.

27. A disposal system of claim 27, further comprising a hood configured to bridge the exchange area.

28. A disposal system of claim 27, wherein the secondary transport mechanism is a trolley.

29. A disposal system of claim 28, wherein the trolley is configured to lock with respect to the hood.

30. A disposal system of claim 27, wherein the housing is a cylindrical housing and wherein the cylindrical housing is sufficiently close to the hood as to block manual access.

31. A disposal system of claim 30, wherein the chute includes a wall structure having a closed periphery.

32. A disposal system of claim 22, wherein the selected waste portion classification includes a recyclable or non-recyclable classification.

33. A disposal system of claim 22, wherein the sorter is detachable from the chute.
